(19) United States
(12) Patent Application Publication
(10) Pub. No.: US 2007/0159685 A1
(43) Pub. Date: Jul. 12, 2007

(54) Telescope with variable magnification

(76) Inventors: Thomas Wagner, Wettenberg (DE); Volker Tautz, Wetzlar (DE)

Correspondence Address: HARNESS, DICKEY & PIERCE, P.L.C., P.O. BOX 828, BLOOMFIELD HILLS, MI, 48303, US

(21) Appl. No.: 11/642,702

(22) Filed: Dec. 20, 2006

(30) Foreign Application Priority Data
Dec. 21, 2005 (DE) 10 2005 063 245.9

(51) Int. Cl. G02B 17/00; G02B 23/00; G02B 21/00

(52) U.S. Cl. 359/365

(57) ABSTRACT

A telescope has an optical axis. As seen from an object side, there are provided along the optical axis an objective lens, two lens groups adapted to be shifted along the optical axis independently from one another and having together a variable magnification, an inversion system, and an eyepiece. An aperture stop is provided between the lens groups, and the aperture stop is adapted to be shifted along the optical axis as a function of the axial position of the lens groups.

### FIELD OF THE INVENTION

The invention is related to the field of telescopes having a variable magnification, also referred to as zooming telescopes.

More specifically, the invention is related to the field of telescopes having an optical axis, wherein, as seen from an object side, there are provided along an optical axis an objective lens, two lens groups adapted to be shifted along the optical axis independently from one another and having together a variable magnification, an inversion system, and an eyepiece.

### BACKGROUND OF THE INVENTION

German disclosure document DE 10 2004 001 481 A1 describes a telescope which, as seen from the object side, is provided with an objective lens, a zooming system consisting of two lens groups, a prism inversion system, and an eye-piece. The telescope is relatively long. No special measures are taken in this telescope for the protection against stray light.

Moreover, U.S. Pat. No. 5,973,861 also discloses telescopes with variable magnification having a zooming and inversion system consisting of two lens groups.

In telescopes, as in other optical observation systems, so-called stray light may occur. This stray light is normally generated in the area of the inversion system. It is imaged together with the object image as such and superimposes on the latter. This results in a deterioration of the image quality. In prior art telescopes the stray light is determined by the clearance or free diameter of the lenses used.

From both German disclosure document DE 36 02 859 A1 and U.S. Pat. No. 4,273,414 a photographic objective lens with variable magnification is known. In this prior art objective lenses, there is provided an aperture stop within the image-sided lens group of the zooming system and is displaced together with the latter. Obviously an inversion system is not provided in these objective lenses.

German patent specification DE 22 59 723 C3 (=GB 1 437 619) discloses a vario objective lens in which the aperture number shall be held constant over the entire focal range. Due to the large zooming range this objective lens is provided with two cascaded zooming systems having each two fixed and two movable lens groups. Between the two zooming systems an aperture stop is provided having an axial position and an opening adapted to be adjusted as a function of the axial position of the movable lens groups. An inversion system is likewise absent.

German disclosure document DE 38 13 992 A1 discloses an eye-piece of variable focal length in which a field stop is provided between the two shiftable lens groups. A field stop, however, in contrast to an aperture stop or a shadowing stop limits the field of vision, i.e. the area of the object plane that may be viewed. A reduction of stray light is not achieved in this way.

### SUMMARY OF THE INVENTION

It is an object underlying the invention to further develop a telescope of the type specified at the outset such that a compact telescope is made available that has less stray light as compared with prior art telescopes.

In a telescope of the type specified at the outset this object is achieved in that an aperture stop is provided between the lens groups, and that the aperture stop is adapted to be shifted along the optical axis as a function of the axial position of the lens groups.

The object underlying the invention is, thus, entirely solved.

By the integration of an aperture stop into the zooming system, a system is namely created in which the effective clearance or free diameter is so small that stray light generated at the inner diameter is stopped down without vignetting the image.

In a preferred improvement of the invention the lens groups configure the inversion system.

This measure has the advantage that a particularly short design is achieved because the inversion system and the zooming system are structurally integrated into one another.

Further, it is particularly preferred when the lens groups are adapted to be shifted along the optical axis by means of a first and a second displacement unit, preferably by means of a first and a second cam groove.

This measure, known per se, has the advantage that the lens groups may be shifted independently from one another, preferably by means of a rotatable ring, the rotational movement of which being transferred into a linear movement along the optical axis by means of the cam grooves.

In this embodiment, in another preferred improvement, the aperture stop may be adapted to be shifted along the optical axis by means of a third displacement unit, preferably by means of a third cam groove, the third displacement unit being independent from the first and the second displacement unit.

This measure has the advantage that the position of the stop may also be almost freely selected in a likewise simple manner, namely together with the rotation of the rotatable ring.

In the afore-mentioned embodiments of the invention the aperture stop is moved along the optical axis in such a way that for any set magnification factor it is located at least approximately at the position where a central ray of the beam of rays, emanating from the vision rim, intersects the optical axis.

This measure has the advantage that the stopping down of the stray light is achieved especially well at any set magnification factor.

In another embodiment of the invention the opening of the aperture stop is adapted to be adjusted as a function of the axial position of the lens groups.

This measure has the advantage that the stopping off of the stray light may be further optimized at any set magnification factor.

For the further optimization of the inventive telescope a first field stop may be arranged between the objective lens and the object-sided lens group, in particular for small magnifications, the first field stop, still more preferably, being located at a fixed position along the optical axis, in particular at a first intermediate image plane.

Likewise, for limiting the field of vision between the image-sided lens group and the eyepiece, a second field stop may be located between the image-sided lens group and the eyepiece, preferably also at a fixed position along the optical axis, in particular at a second intermediate image plane.

Finally, a field lens may be located between the objective lens and the object-sided lens group, in particular at a first intermediate image plane, wherein the field lens, preferably, may be combined with a reticle.

Further advantages will become apparent from the description and the enclosed drawing.

It goes without saying that the features mentioned before and those that will be explained hereinafter may not only be used in the particularly given combination but also in other combinations, or alone, without leaving the scope of the present invention.

### BRIEF DESCRIPTION OF THE DRAWINGS

Embodiments of the invention are depicted in the drawings and will be explained in further detail in the subsequent description in which

FIG. 1 in a schematic depiction shows a ray path of an embodiment of a telescope according to the invention;

FIG. 2 as an enlarged portion of FIG. 1 shows an inversion system with variable magnification; and

FIG. 3 in five partial depictions a) through e) shows operational positions of lens groups of the telescope at different magnifications.

### DETAILED DESCRIPTION OF THE PREFERRED EMBODIMENTS

In FIG. 1, reference numeral 10 as a whole designates an embodiment of a telescope according to the present invention being schematically illustrated with its ray path. Telescope 10 has an optical axis 12. In FIG. 1 the object side 14 is shown left and the image side 15 is shown right.

On object side 14 one can see an objective lens 16 which, as the case may be, may be provided with an objective lens aperture stop 17 or may configure same itself.

On the right hand side next to objective lens 16 an inversion system 18, also referred in the art as erection system, with variable magnification is shown on optical axis 12. It is, therefore, a system which combines in itself both functions, namely a variable magnification and an image inversion.

Inversion system 18 is provided with a first lens group 20 as well as with a second lens group 22 arranged at a predetermined axial distance with respect to one another.

Finally, there is still an eyepiece 23 arranged on image side 15 of telescope 10.

Lens groups 20 and 22 are adapted to be individually shifted along optical axis 12, as indicated by arrows 24 and 26. Any appropriate displacement unit may be used for shifting lens groups 20 and 22. However, manually operated or motorized mechanical displacement units with a first and a second cam groove 28, 30, respectively, are preferred, as known per se.

An aperture stop or a shadowing stop 40 is provided between lens groups 20 and 22. As is generally known, an aperture or shadowing stop, in contrast to a field stop, does not influence the field of vision. It determines the size of the beam of rays for the imaging of the axial point and thereby suppresses stray light which is generated outside the beam of rays required for the imaging. An aperture stop, therefore, has the same function as a conventional iris diaphragm in a photo camera.

Aperture stop 40 is also adapted to be shifted along optical axis 12 as indicated by an arrow 42, and, preferably, likewise by means of a third cam groove 44. Insofar, the shifting of aperture stop 40 is effected as a function of the actually set magnification, i.e. as a function of the actual axial position of lens groups 20 and 22.

Between objective lens 16 and first object-sided lens group 20, there is arranged a first field lens 48, preferably at a fixed position and at a first intermediate image plane 46, as well as, preferably, a first field stop 50, in particular for small magnifications. First field lens 48 may be provided with a reticle if telescope 10 is an aiming telescope. First field lens 48 and first field stop 50 may be structurally integrated into one another.

Between second, image-sided lens group 22 and eyepiece 23, there is arranged a second field stop 54, preferably at a fixed position and at a second intermediate image plane 52.

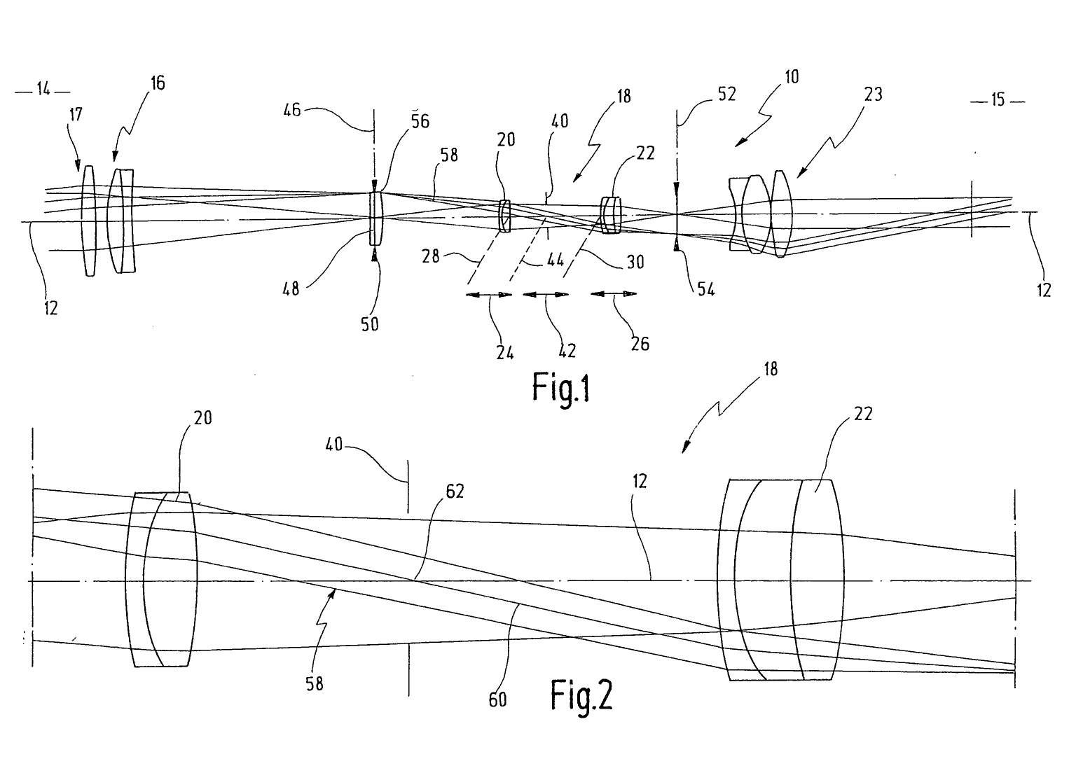

The given axial position of aperture stop 40 shall now be discussed with the help of FIG. 1 as well as the enlarged depiction of inversion system 18 in FIG. 2:

The field of vision is limited at first intermediate image plane 46, be it by the clearance of first field lens 48 or by first field stop 50, if any is provided. Thereby, a vision rim 56 is defined (FIG. 1). A beam 58 of rays (FIGS. 1 and 2) emanating from vision rim 56 travels trough first lens group 20. A central ray 60 of beam 58 of rays intersects optical axis 12 at a position 60. Position 60 determines the optimum position of aperture stop 40.

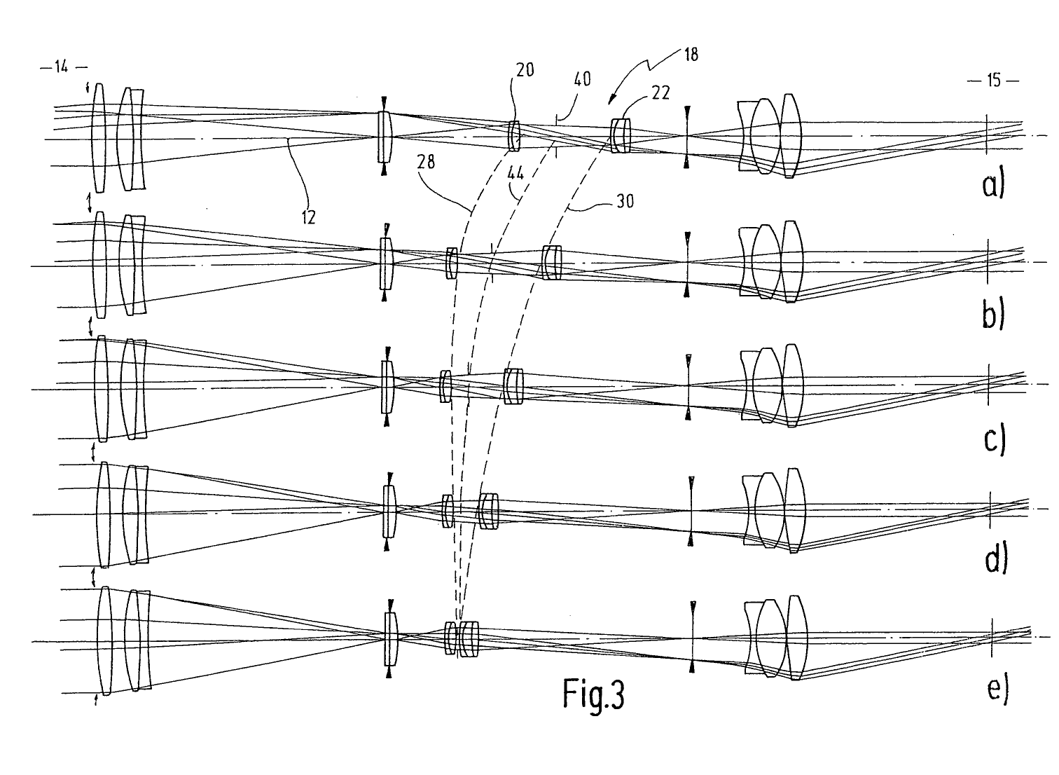

FIG. 3, finally, shows five different settings a) through e) of telescope 10, wherein a) depicts the lowest and e) the highest magnification. The three cam grooves 28, 30 and 44 which approximately meet in setting e) are clearly visible.

1. A telescope having an optical axis, wherein, as seen from an object side, there are provided along an optical axis an objective lens, two lens groups adapted to be shifted along said optical axis independently from one another and having together a variable magnification, an inversion system, and an eyepiece, wherein, further, an aperture stop is provided between said lens groups, said aperture stop being adapted to be shifted along said optical axis as a function of the axial position of said lens groups.

2. The telescope of claim 1, wherein said lens groups configure said inversion system.

3. The telescope of claim 1, wherein said lens groups are adapted to be shifted along said optical axis by means of a first and a second displacement unit.

4. The telescope of claim 3, wherein said first and second displacement unit are configured as a first and a second cam groove.

5. The telescope of claim 3, wherein said aperture stop is adapted to be shifted along said optical axis by means of a third displacement unit, said third displacement unit being independent from said first and said second displacement unit.

6. The telescope of claim 5, wherein said third displacement unit is configured as a third cam groove.

7. The telescope of claim 1, wherein said aperture stop is moved along said optical axis in such a way that for any set magnification factor said aperture stop is located essentially at a position where a central ray of a beam of rays, originating from an actual vision rim, intersects said optical axis.

8. The telescope of claim 1, wherein an opening of said aperture stop is adapted to be adjusted as a function of an axial position of said lens groups.

9. The telescope of claim 1, wherein a first field stop is arranged between said objective lens and one of said lens groups being object-sided.

10. The telescope of claim 9, wherein said first field stop is located at a fixed position along said optical axis.

11. The telescope of claim 10, wherein said first field stop is located at a first intermediate image plane.

12. The telescope of claim 1, wherein a second field stop is located between one of said lens groups being image-sided and said eyepiece.

13. The telescope of claim 12, wherein said second field stop is located at a fixed position along said optical axis.

14. The telescope of claim 13, wherein said second field stop is located at a second intermediate image plane.

15. The telescope of claim 1, wherein a field lens is located between said objective lens and one of said lens groups being object-sided.

16. The telescope of claim 15, wherein said field lens is combined with a reticle.

17. The telescope of claim 16, wherein said field lens is located at a first intermediate image plane.
